(19) United States
(12) Patent Application Publication
(10) Pub. No.: US 2020/0159638 A1
(43) Pub. Date: May 21, 2020

(54) Collaborative Decision Making to Enhance Resiliency of Workloads in Data Center Environments

(71) Applicant: International Business Machines Corporation, Armonk, NY (US)

(72) Inventors: Manish Gupta, Noida (IN); Sreekrishnan Venkateswaran, Bangalore (IN)

(21) Appl. No.: 16/197,088

(22) Filed: Nov. 20, 2018

(51) Int. Cl. G06F 11/34; G06F 11/20; G06F 9/54; G06F 9/50

(52) U.S. Cl. CPC G06F 11/3433; G06F 11/2023; G06Q 50/01; G06F 9/505; G06F 11/3452; G06F 9/542

(57) ABSTRACT

An approach is provided in which a system subscribes a set of workloads executing on a data center to a set of data sources that provide a set of data. The system analyzes the set of data against one or more thresholds, and the analyzing indicates at least one impending workload-specific event corresponding to at least one workload in the set of workloads. In turn, the system generates a workload-specific alert corresponding to the identified workload based on the impending workload-specific event.

### BACKGROUND

Today's data center environment disaster detection approaches are reactive and, at times, do not have enough time to provide adequate protection. For example, when a database server in a particular fire zone is down due to a fire, only after the fact does a failover transpire to a standby database server in a nearby fire zone or a disaster recovery replica that is hundreds of miles away. This last minute failover is fraught with higher risk of failure in systems having stringent high availability (HA) or disaster recovery (DR) requirements. High availability refers to a technology design that minimizes information technology (IT) disruptions by providing IT continuity through redundant or fault-tolerant components. Disaster recover refers to a pre-planned approach for reestablishing IT functions and their supporting components at an alternate facility when normal repair activities cannot recover them in a reasonable timeframe.

Disaster recovery focuses on two key considerations, which are Recovery Point Objective (RPO) and Recovery Time Objective (RTO). RPO is the time during a disaster before the amount of data lost exceeds the tolerance threshold outlined in a business continuity plan. RTO is the actual time in which an application or service must be recovered according to the business continuity plan. Disaster recovery typically involves a set of policies, tools, and procedures to enable the recovery or continuation of vital technology infrastructure and systems following a natural or human-induced disaster.

Today's systems do not have a cooperative decision making solution for workload managers and, in turn, there is no way in which a workload learns from other peer workloads how to proactively respond to possible upcoming non-workload based events and increase resiliency based on the other peer workloads' past decisions. As defined herein, a non-workload based event for a specific workload is any event not owned by the specific workload.

In computer technology, a workload refers to: (i) the amount of processing that the computer has been (or will be) given to do at a given time; and/or (ii) the computing tasks that correspond to the amount of processing that the computer has been (or will be) given to do at a given time. A workload typically includes: (i) processing associated with some amount of application programming running in the computer; and (ii) some amount of processing with users connected to and interacting with the computer's applications. A defined workload can act as a benchmark when evaluating performance parameters of a computer system. Such measured performance parameters typically include: (i) response time (the time between a user request and a response to the request from the system); and (ii) throughput (how much work is accomplished over a period of time).

### BRIEF SUMMARY

According to one embodiment of the present disclosure, an approach is provided in which a system subscribes a set of workloads executing on a data center to a set of data sources that provide a set of data. The system analyzes the set of data against one or more thresholds, and the analyzing indicates at least one impending workload-specific event corresponding to at least one workload in the set of workloads. In turn, the system generates a workload-specific alert corresponding to the identified workload based on the impending workload-specific event.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present disclosure, as defined solely by the claims, will become apparent in the non-limiting detailed description set forth below.

According to an aspect of the present invention there is a method, system and/or computer program product that performs the following operations (not necessarily in the following order): (i) subscribing a set of workloads to a set of data sources, wherein the set of workloads execute on a data center and the set of data sources generate a set of data; (ii) evaluating the set of data against one or more thresholds, wherein the evaluating identifies an impending workload-specific event corresponding a first workload in the set of workloads; and (iii) generating a workload-specific alert corresponding to the first workload based on the impending workload-specific event.

### BRIEF DESCRIPTION OF THE SEVERAL VIEWS OF THE DRAWINGS

The present disclosure may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is an exemplary diagram depicting an environmental monitor service interacting with a proactive action manager to proactively invoke disaster recovery operations on a per-workload basis;

FIG. 4 is an exemplary diagram depicting a source subscription manager receiving environmental data from environmental sensors;

FIG. 5 is an exemplary table depicting various examples of sources that provide environmental data, infrastructure data, and social media data;

FIG. 6 is an exemplary diagram depicting collaborative workload decision making service receiving states from various workloads and providing a platform to collaborate between workloads;

FIG. 7 is an exemplary diagram depicting workload interactions using social media messages; and

FIG. 8 is an exemplary flowchart showing steps taken in proactively managing workload-specific disaster recovery operations.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. The following detailed description will generally follow the summary of the disclosure, as set forth above, further explaining and expanding the definitions of the various aspects and embodiments of the disclosure as necessary.

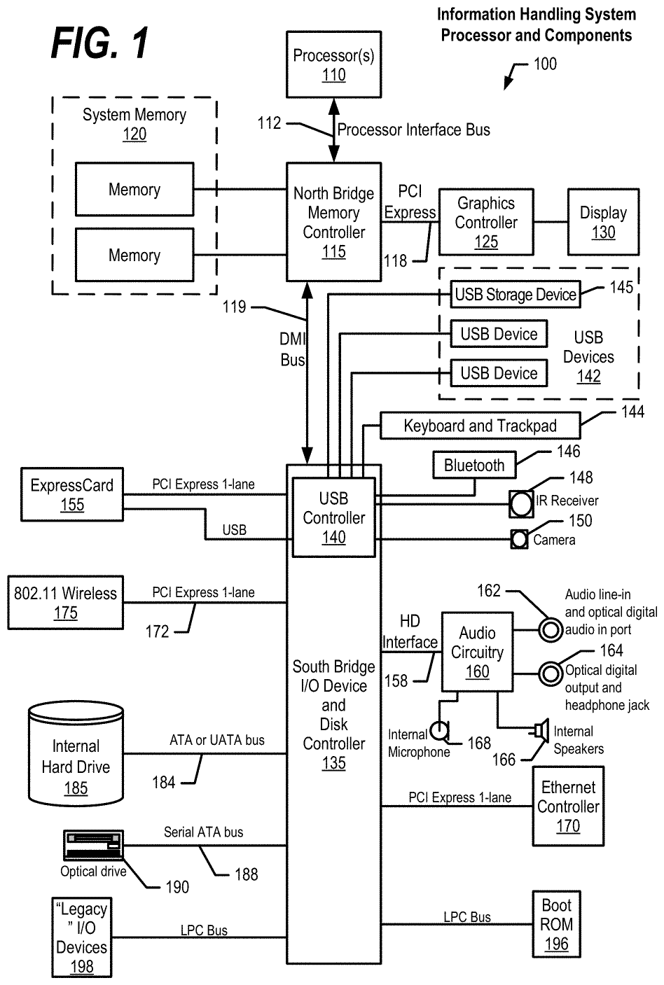

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, Peripheral Component Interconnect (PCI) Express bus 118 connects Northbridge 115 to graphics controller 125. Graphics controller 125 connects to display device 130, such as a computer monitor.

Northbridge 115 and Southbridge 135 connect to each other using bus 119. In some embodiments, the bus is a Direct Media Interface (DMI) bus that transfers data at high speeds in each direction between Northbridge 115 and Southbridge 135. In some embodiments, a PCI bus connects the Northbridge and the Southbridge. Southbridge 135, also known as the Input/Output (I/O) Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and Universal Serial Bus (USB) connectivity as it connects to Southbridge 135 using both the USB and the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, Integrated Services Digital Network (ISDN) connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the Institute of Electrical and Electronic Engineers (IEEE) 802.11 standards of over-the-air modulation techniques that all use the same protocol to wireless communicate between information handling system 100 and another computer system or device. Optical storage device 190 connects to Southbridge 135 using Serial Analog Telephone Adapter (ATA) (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality associated with audio hardware such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, Automated Teller Machine (ATM), a portable telephone device, a communication device or other devices that include a processor and memory.

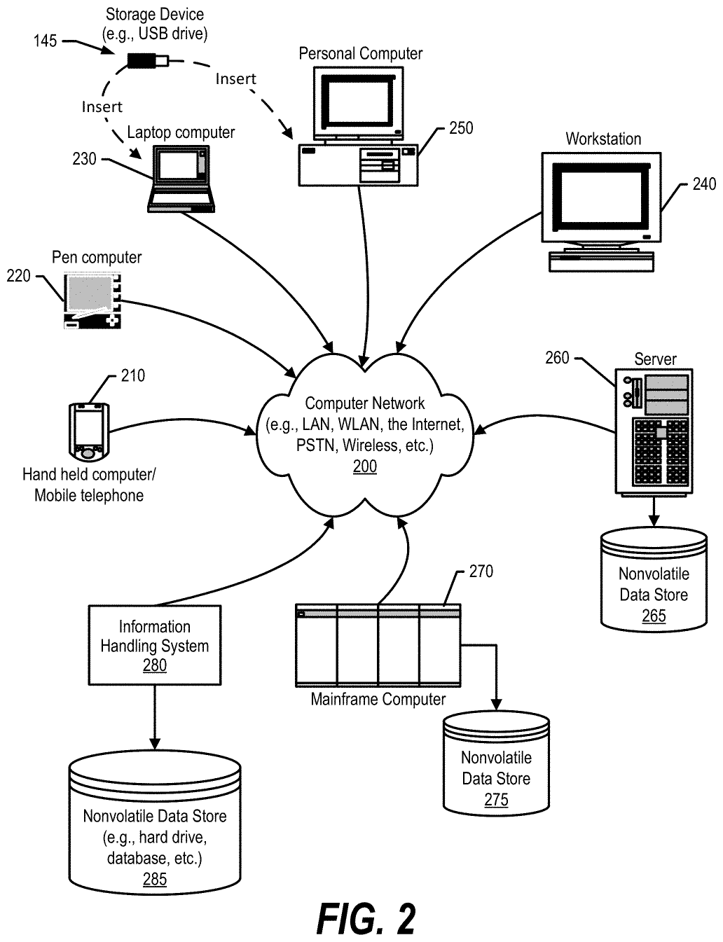

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as Moving Picture Experts Group Layer-3 Audio (MP3) players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. The embodiment of the information handling system shown in FIG. 2 includes separate nonvolatile data stores (more specifically, server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

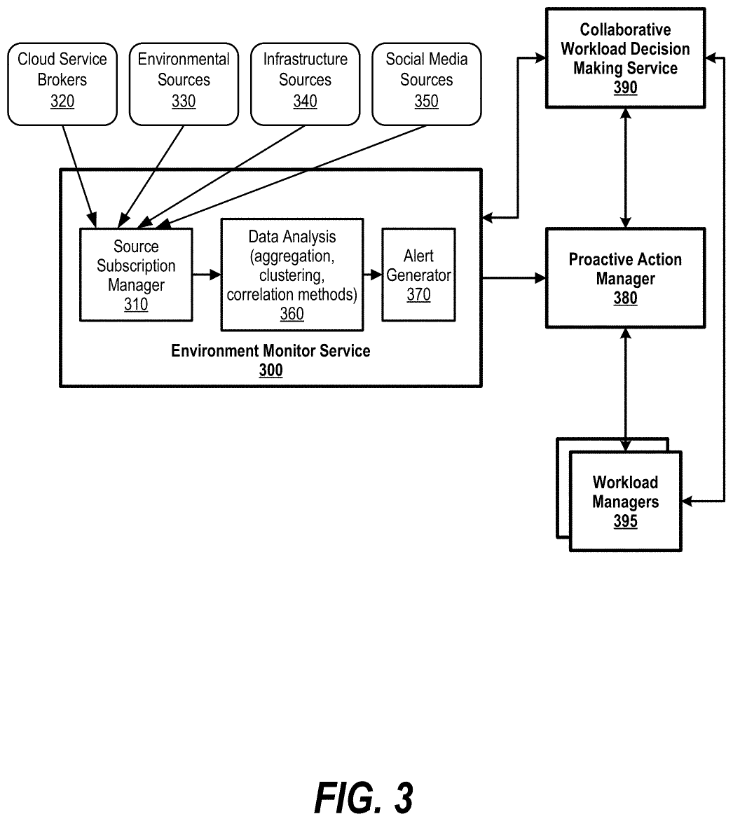

As discussed above, today's disaster recovery solutions operate on a reactive basis and, at times, do not have enough time to execute disaster recovery operations. FIGS. 3 through 8 depict an approach that can be executed on an information handling system that proactively triggers workload managers to begin failover of a workload based on non-workload based events and data shared by other workloads. In one embodiment, the data is shared between workloads through workload decision making services that store key IT data from workloads, and/or through cloud service brokers that monitor the health parameters of the various cloud data centers.

In one embodiment, the approach subscribes to data/events from data sources such as environmental sensors, social media sites, internal services, and/or external services. Then, the approach analyzes the incoming data/events and estimates whether a disaster probability is greater than a particular threshold or obtains a probability of outage for a data center/rack/etc. from a Cloud Service Broker (CSB). In turn, the approach invokes the corresponding workload managers to begin a failover and update the status of the workload into the workload decision making service.

In one embodiment, the approach provides a data center wide service that brokers information and data analysis and to which a HA or DR manager for a workload subscribes. The approach raises environment alerts and provides raw measured data that is used by an HA or DR manager to take proactive actions such as moving from async-mode of replication to sync mode of replication, increasing wide area network (WAN) bandwidth, initiate failover, “tweet” a decision and the goodness of the decision, etc. In turn, other workloads can analyze the decision taken by other workloads to modulate their own decision.

In one embodiment, the approach enables availability, security, and performance related workload managers to proactively take actions based on non-workload events causing workload-specific outages, such as HA failures. In this embodiment, the workload-specific alert is not merely alerts declaring expected disasters but rather ‘more social’. The approach disseminates alerts to all the workload managers that have subscribed to them.

In one embodiment, the approach takes actions to improve quality of service (QoS)/Availability/security posture/performance and shares action's success with other workloads. In another embodiment, the approach subscribes environmental sensors in the data center environment, external data service, or Internet accessible data service. In this embodiment, cloud service brokers maintain uptime-awareness of brokered infrastructure elements. In another embodiment, the approach correlates different data points/streams; aggregates/clusters the data; computes heuristic functions of the sensory data; and computes change points in data streams.

In another embodiment, the approach analyzes the environment data and detects an impending client cloud environment outage by leveraging a cloud service broker that maintains an outage vector that includes probabilistic downtimes of various infrastructure elements in hybrid environments under its provisioning scope. In this embodiment, the cloud service broker observes patterns of value-bounds or thresholds in the outage vector that existed prior to past environment outages. The cloud service broker also builds a top-down awareness of client-specific hybrid deployment architecture and predicts failures based on the top-down awareness.

In another embodiment, the approach receives data from one or more sources and estimates the probability or likelihood or time to disaster or any other measure that signifies how “far away” is the disaster. The approach allows subscription by multiple workloads with their own custom policies. Subscription can be on raw metrics such as temperature, humidity, smoke, etc. In this embodiment, when a policy is triggered, a DR workload-specific alert is raised for consumption by the DR broker service.

In another embodiment, policies are created to decide when to perform a particular task associated with failover, such as the failover itself or moving from async replication to sync replication. For example, if probability>T then trigger DR alert (where T is a customer defined threshold), or if temperature>T then trigger DR workload-specific alert (where T is a customer defined threshold).

When processing workloads, there can be two types of events/failures (referred to herein as events): workload-specific events and non-workload-specific events. Workload-specific events are particular to specific workloads and non-workload-specific events pertain to the environment and surroundings that do not directly impact the workloads (e.g., datacenters, networks, social events, etc.). Examples of types of non-workload-specific events include the following: (i) physical security breach event, (ii) power distribution event, (iii) managed IT event, (iv) storage event, (v) network event, (vi) intrusion event, (vii) datacenter application affected event, (viii) logical security breach event, (ix) network accessible service event, (x) primary datacenter inaccessibility event, (xi) application inaccessibility event, (xii) domain name inaccessibility event, (xiii) air conditioning event, (xiv) temperature event, (xv) static electricity event, (xvi) humidity event, (xvii) floor water leak event, (xviii) smoke event, (xix) earth quake event, (xx) tornado event, (xxi) snow event, (xxii) rain event, (xxiii) flood event, (xxiv) tsunami event, (xxv) volcano event, (xxvi) building collapse event, (xxvii) curfew event, (xxviii) riot event, (xxix) war event, (xxx) pandemic event, (xxxi) labor stoppage event, (xxxii) picketing event, and (xxxiii) social media event. Examples of types of workload-specific events include the following: (i) operating system (OS) event (crash) running the workload, (ii) server event (crash or a severe performance degradation) running the OS that is running the workload, (iii) storage event (crash or a severe performance degradation) running the OS that is running the workload, (iv) network event (crash or a severe performance degradation) running the OS that is running the workload, (v) workload crash due to a bug in the application code, (vi) workload crash because it was subjected to a load that it was not designed to serve (e.g., an e-commerce platform designed for 100K simultaneous users is subjected to 1 M simultaneous users), (vii) workload crash due to another misbehaving workload with whom it is sharing some infrastructure, (viii) workload-specific performance degradation detection (slow response times), (ix) predicted future workload-specific performance degradation detection (slow response times), (x) detection of an event that predicts/points to a future workload crash as a result of performing analytics on past data (e.g., infer that a workload is likely to fail if the storage utilization increases beyond 90%), and (xi) workload behavioral patterns alerts (e.g., observation that the load on the workload will peak on weekends, but the compute utilization while approaching the weekend is very high). In one embodiment, workload-specific events are a manifestation of non-workload-specific events, such as a hardware server failing (workload-specific) due to a fire (non-workload-specific) that was executing a workload.

FIG. 3 is an exemplary diagram depicting an environmental monitor service interacting with a proactive action manager to proactively invoke disaster recovery operations on a per-workload basis.

Environmental monitor service 300 generates alerts that indicate impending problematic situations such as a partial availability or a disaster scenario. The alerts can be consumed by any workload management component or the workload directly to take appropriate actions. In one embodiment, worker managers 395 include workload HA managers, workload DR managers that manage failover and subsequent failback, and/or performance/security managers.

Environmental monitor service 300 includes source subscription manager 310 that receives data from various sources such as cloud service brokers 320, environmental sources 330, infrastructure sources 340, and social media sources 350. Environmental sources 330 includes heat monitors, smoke detectors, moisture monitors, or any type of environmental sensor that monitors the environmental characteristics surrounding IT components. Infrastructure sources 340 includes event management systems, service management systems, etc. Social media sources 350 include Internet-based sites such as social media sights.

Cloud service brokers (CSBs) 320 operate at a cross-cloud cross-client vantage points over extended amounts of time and, as such, have natural visibilities to present and past states of infrastructure elements in various cloud data centers under their provisioning control. In one embodiment, cloud service brokers 320 are uptime-aware and client-architecture-aware cloud brokers that maintain an ‘outage vector’ that tracks 1) probabilistic downtimes of various infrastructure elements in hybrid environments under its provisioning scope; 2) average number of yearly outages experienced by all brokered infrastructure elements and their repair times (MTBF & MTTR). Cloud service brokers 320 also (i) observes patterns of value-bounds/thresholds in the outage vector that existed prior to past data center and component-level outages; (ii) has awareness of client-specific hybrid deployment architectures; (iii) monitors the current state of various infrastructure components of each client deployment. Cloud service brokers 320, in turn, predicts impending HA outages of a given client IT architecture hosted on a brokered cloud and pro-actively declares client-specific disasters.

Source subscription manager 310 feeds the received data into data analysis 360, which correlates different data points/streams, aggregates/clusters the data, computes heuristical functions of the sensory data, and computes anomalies in data streams. In turn, data analysis 360 sends results to alert generator 370 that includes information such as time to disaster, probability of disaster, likelihood of disaster, temperature anomalies, humidity anomalies, etc. Alert generator 370 analyzes the data against thresholds and sends conditional workload-specific alerts as needed to proactive action manager 380. In one embodiment, data analysis 360 and alert generator 370 work in combination to compare the incoming data against thresholds.

Proactive action manager 380, in one embodiment, is a software agent that runs per workload per customer account façade that interfaces between environmental monitor service 300, collaborative workload decision making service 390, and workload managers 395 for workloads. In one embodiment, proactive action manager 380 is two clients in which one client interfaces with environmental monitor service 300 and another client interfaces with collaborative workload decision making service 390. To share states with collaborative workload decision making service 390, proactive action manager 380 gathers information directly from the workload or via worker managers 395 or environmental monitor service 300. In another embodiment, proactive action manager 380 is a client for environmental monitor service 300 and receives data/alerts from environmental monitor service 300 and uses APIs of workload managers 395 to perform requisite actions, such as failover, migration, deletion of data, scaling out, etc.

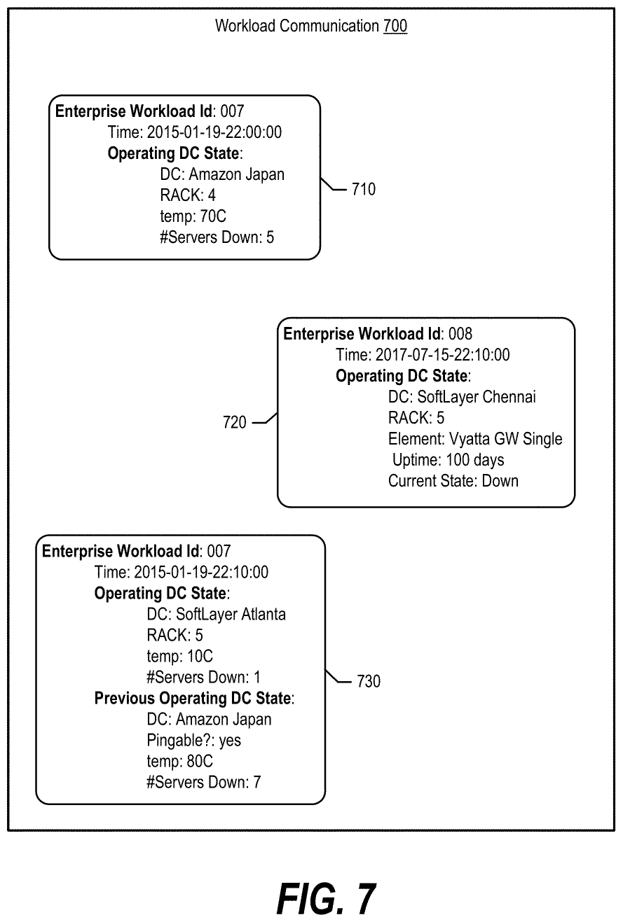

In one embodiment, collaborative workload decision making service 390 provides the ability for a workload (via its manager) to “tweet” its state and decision taken, given the state (see FIG. 7 and corresponding text for further details). Collaborative workload decision making service 390 also maintains a repository for previous decisions taken by workloads to allow any subscriber to read those decisions.

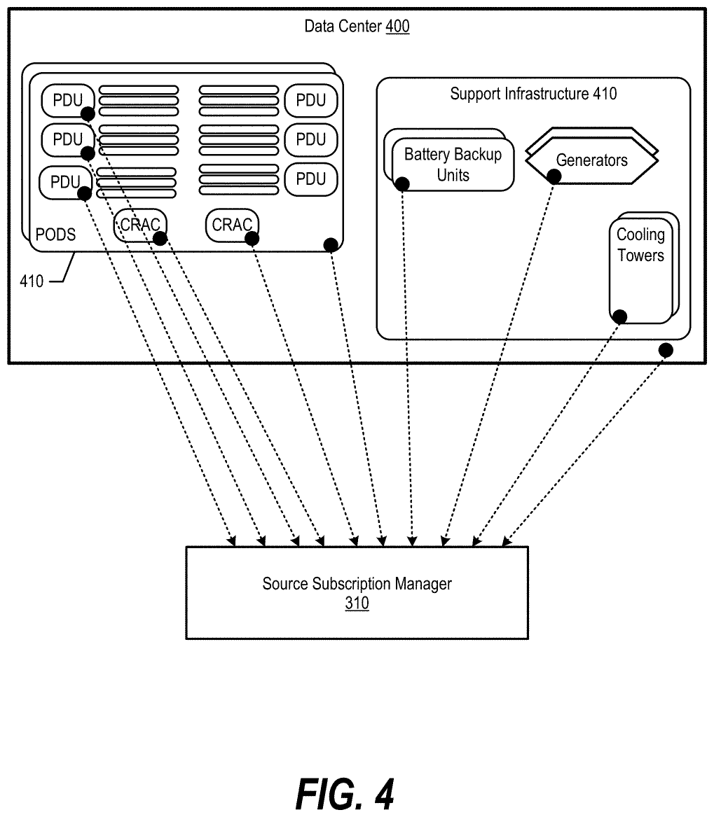

FIG. 4 is an exemplary diagram depicting a source subscription manager receiving environmental data from environmental sensors (environmental sources 330). Data center 400 includes pots 410 and support infrastructure 410, both of which include various types of environmental sensors (black dots), such as heat sensors, smoke sensors, moisture sensors, etc.

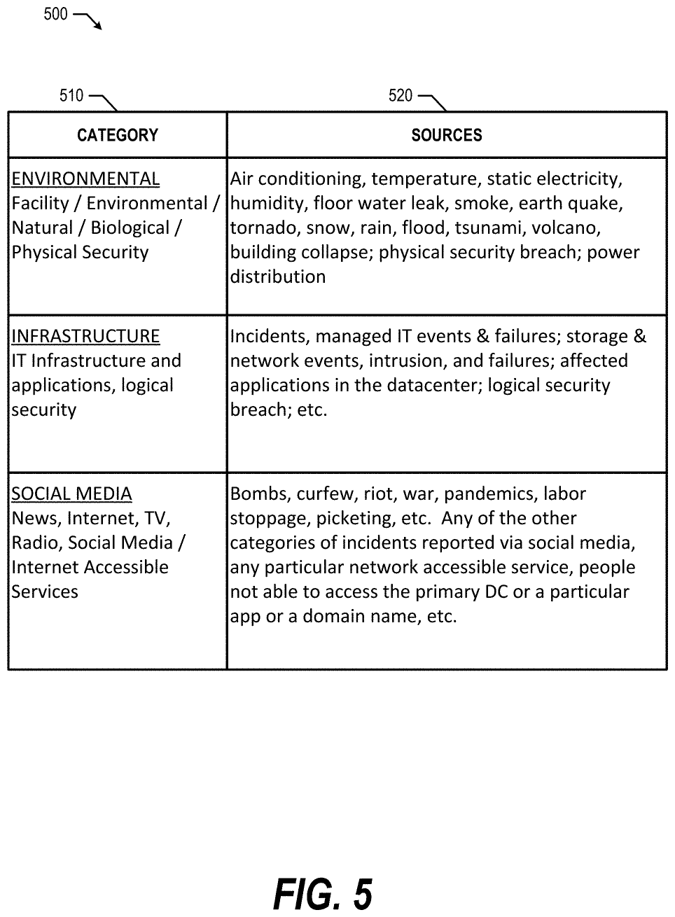

FIG. 5 is an exemplary table depicting various examples of sources that provide environmental data, infrastructure data, and social media data. Table 500 includes categories in column 510 that correspond to sources 330, 340, and 350 in FIG. 3. Column 520 includes examples of the source types in column 510.

Different sources of information are used by models of disaster prediction. The sources could be internal or external to the data center and could be analog or digital. In one embodiment, the approach described herein encompasses one or more prediction methods into disaster prediction in the context of proactive disaster recovery. In this embodiment, the approach combines a disaster prediction method via a disaster prediction component to proactively cause failover of a workload.

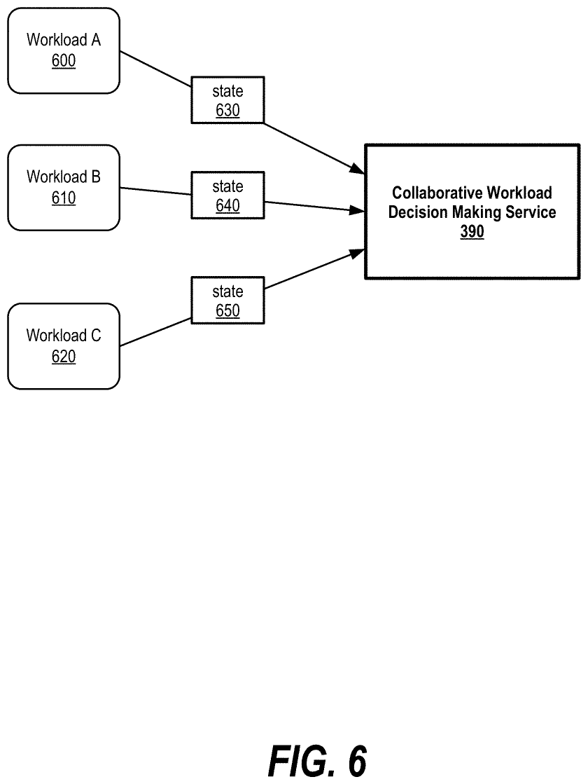

FIG. 6 is an exemplary diagram depicting collaborative workload decision making service 390 receiving states from various workloads and providing a platform to collaborate between workloads. Periodically, workloads 600, 610, and 620 (through their corresponding workload managers 395) update collaborative workload decision making service 390 with their corresponding states 630, 640, and 650. Collaborative workload decision making service 390 provides information back to the workloads such as how many workloads have failed in a data center or have migrated over to another data center, temperature changes, etc. Collaborative workload decision making service 390 also provides the state information to environmental monitor service 300 for future decision making steps.

FIG. 7 is an exemplary diagram depicting workload messages collected by collaborative workload decision making service 390 and utilized to determine workload-specific disaster recovery steps. Workload communication 700 shows that workload 007 generated message 710 that includes the data center on which it executes (Amazon Japan), its corresponding rack (4), temperature (70 C), and the number of servicers down in the data center (5), which is substantial.

Message 720 shows workload 008's location and that it is currently in a down state. Message 730 shows that proactive action manager 380 migrated workload 007 from its previous data center to a new data center other than workload 008's data center.

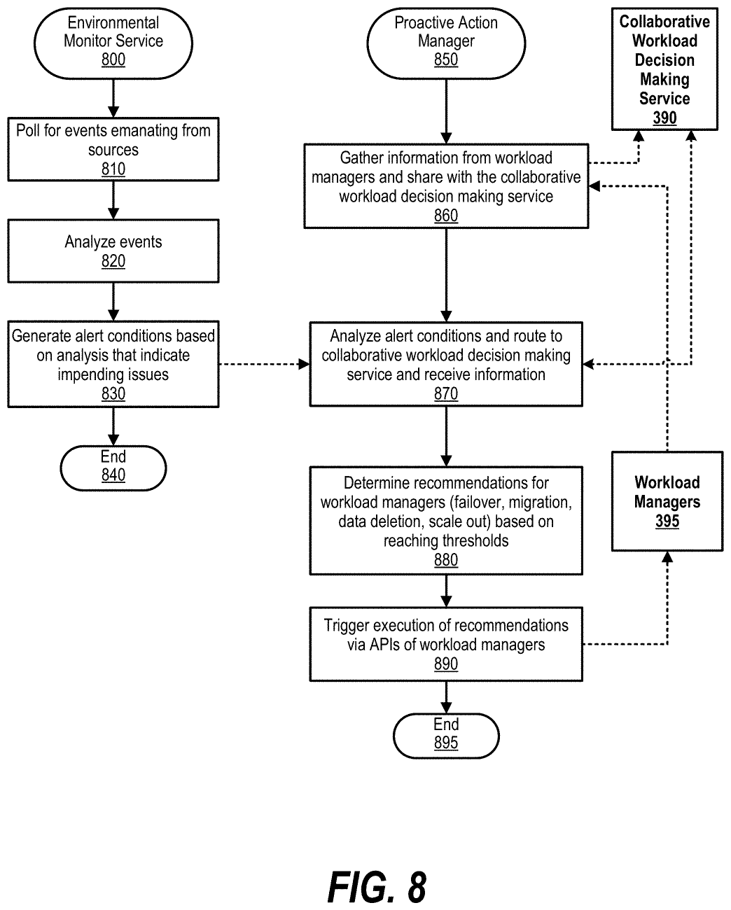

FIG. 8 is an exemplary flowchart showing steps taken in proactively managing workload-specific disaster recovery operations. Environmental monitor service 300 processing commences at 800 whereupon, at step 810, the process polls for events emanating from various data sources. At step 820, the process analyzes the polled events and, at step 830, the process generates alerts based on analysis that indicate impending issues and sends the alerts to proactive action manager 380. Environmental monitor service 300 processing thereafter ends at 840.

Proactive action manager 380 processing commences at 850 whereupon, at step 860, the process gathers workload state information from workload managers 395 and shares the information with collaborative workload decision making service 390. In one embodiment, collaborative workload decision making service 390 receives the workload state information directly from workload managers 395.

At step 870, the process analyzes the workload-specific alert condition information received from environmental monitoring service 300, routes the workload-specific alert condition information to collaborative workload decision making service 390, and receives a response. For example, the workload-specific alert condition may be that a data center is overheating and collaborative workload decision making service 390 analyzes information from other workloads to determine if another data center is available to migrate a workload that is executing on the overheating data center.

At step 880, the process determines recommendations for workload managers 395 based on step 870 (failover, migration, data deletion, scale out) and, at step 890, the process triggers execution of recommendations via APIs of workload managers 395. Proactive action manager 380 processing thereafter ends at 895.

While particular embodiments of the present disclosure have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the disclosure is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to disclosures containing only one such element, even when the same claim includes the introductory phrases “one or more” or “at least one” and indefinite articles such as “a” or “an”; the same holds true for the use in the claims of definite articles.

1. A method implemented by an information handling system that includes a memory and a processor, the method comprising:
subscribing a set of workloads to a set of data sources, wherein the set of workloads execute on a data center and the set of data sources generate a set of data;
evaluating the set of data against one or more thresholds, wherein the evaluating identifies an impending workload-specific event corresponding a first workload in the set of workloads; and
generating a workload-specific alert corresponding to the first workload based on the impending workload-specific event.

2. The method of claim 1 wherein the evaluating further comprises:
receiving a message that comprises a state of a second workload; and
leveraging the state of the second workload during the identification of the impending workload-specific event of the first workload.

3. The method of claim 2 wherein the first workload executes on a first data center and the second workload executes on a second data center that is different from the first data center.

4. The method of claim 1 wherein at least one of the set of data sources is a cloud service broker, the method further comprising:
maintaining, by the cloud service broker, an outage vector that comprises one or more probabilistic downtimes of one or more infrastructure elements, wherein the data center comprises at least one of the one or more infrastructure elements;
detecting an impending client cloud environment outage based on the outage vector; and
generating a different workload-specific alert corresponding to the first workload based on the client cloud environment outage.

5. The method of claim 1 wherein the set of data comprises non-workload data unrelated to the identified at least one workload.

6. The method of claim 1 wherein at least one of the set of data sources is selected from the group consisting of an environmental sensor, a social media site, an internal service, a cloud service broker, and an external service.

7. The method of claim 1 further comprising:
in response to the generating of the workload-specific alert, performing at least one action to improve at least one metric in the data center to prepare the workload for failover, wherein the at least one metric is selected from the group consisting of a quality of service metric, an availability metric, a network bandwidth metric, and a performance metric.

8. The method of claim 1 wherein the set of data comprises a set of data streams, and wherein the evaluating further comprises:
correlating the set of data streams;
computing one or more heuristic functions of the correlated set of data streams; and
computing one or more change points in the set of correlated data streams based on the one or more heuristic functions, wherein the one or more change points correspond to the impending workload-specific event.

9. The method of claim 1 wherein the set of data is a social media message generated from a second workload.

10. An information handling system comprising:
one or more processors;
a memory coupled to at least one of the processors;
a set of computer program instructions stored in the memory and executed by at least one of the processors in order to perform actions of:
subscribing a set of workloads to a set of data sources, wherein the set of workloads execute on a data center and the set of data sources generate a set of data;
evaluating the set of data against one or more thresholds, wherein the evaluating identifies an impending workload-specific event corresponding a first workload in the set of workloads; and
generating a workload-specific alert corresponding to the first workload based on the impending workload-specific event.

11. The information handling system of claim 10 wherein the processors perform additional actions comprising:
receiving a message that comprises a state of a second workload; and
leveraging the state of the second workload during the identification of the impending workload-specific event of the first workload.

12. The information handling system of claim 10 wherein at least one of the set of data sources is a cloud service broker, and wherein the processors perform additional actions comprising:
maintaining, by the cloud service broker, an outage vector that comprises one or more probabilistic downtimes of one or more infrastructure elements, wherein the data center comprises at least one of the one or more infrastructure elements;
detecting an impending client cloud environment outage based on the outage vector; and
generating a different workload-specific alert corresponding to the first workload based on the client cloud environment outage.

13. The information handling system of claim 10 wherein the set of data comprises non-workload data unrelated to the identified at least one workload.

14. The information handling system of claim 10 wherein at least one of the set of data sources is selected from the group consisting of an environmental sensor, a social media site, an internal service, a cloud service broker, and an external service.

15. The information handling system of claim 10 wherein the processors perform additional actions comprising:
in response to the generating of the workload-specific alert, performing at least one action to improve at least one metric in the data center to prepare the workload for failover, wherein the at least one metric is selected from the group consisting of a quality of service metric, an availability metric, a network bandwidth metric, and a performance metric.

16. A computer program product stored in a computer readable storage medium, comprising computer program code that, when executed by an information handling system, causes the information handling system to perform actions comprising:
subscribing a set of workloads to a set of data sources, wherein the set of workloads execute on a data center and the set of data sources generate a set of data;
evaluating the set of data against one or more thresholds, wherein the evaluating identifies an impending workload-specific event corresponding a first workload in the set of workloads; and
generating a workload-specific alert corresponding to the first workload based on the impending workload-specific event.

17. The computer program product of claim 16 wherein the information handling system performs further actions comprising:
receiving a message that comprises a state of a second workload; and
leveraging the state of the second workload during the identification of the impending workload-specific event of the first workload.

18. The computer program product of claim 16 wherein at least one of the set of data sources is a cloud service broker, and wherein the information handling system performs further actions comprising:
maintaining, by the cloud service broker, an outage vector that comprises one or more probabilistic downtimes of one or more infrastructure elements, wherein the data center comprises at least one of the one or more infrastructure elements;
detecting an impending client cloud environment outage based on the outage vector; and
generating a different workload-specific alert corresponding to the first workload based on the client cloud environment outage.

19. The computer program product of claim 16 wherein the set of data comprises non-workload data unrelated to the identified at least one workload.

20. The computer program product of claim 16 wherein the information handling system performs further actions comprising:
in response to the generating of the workload-specific alert, performing at least one action to improve at least one metric in the data center to prepare the workload for failover, wherein the at least one metric is selected from the group consisting of a quality of service metric, an availability metric, a network bandwidth metric, and a performance metric.
